(19) United States
(12) Patent Application Publication
(10) Pub. No.: US 2018/0354425 A1
(43) Pub. Date: Dec. 13, 2018

(54) VEHICLE TRUNK

(71) Applicant: FORD GLOBAL TECHNOLOGIES, LLC, Dearborn, MI (US)

(72) Inventors: Joshua Scott SMITH, Allen Park, MI (US); Victoria Leigh SCHEIN, Dearborn, MI (US)

(21) Appl. No.: 15/621,032

(22) Filed: Jun. 13, 2017

(51) Int. Cl. B60R 7/00; B60R 7/02; B60R 5/04

(52) U.S. Cl. CPC B60R 7/005; B60R 7/02; B60R 5/00; B60R 7/00; B60R 5/04

(57) ABSTRACT

A vehicle trunk includes a retractable carriage that is extendable from a position flush with a floor of the trunk, and mountable to opposing walls of the trunk when extended. The trunk further includes retractable dividers that are extendable from the floor, each having a rod at a free end thereof. The carriage is configured to receive first ends of the rods for supporting the respective divider when extended to form a customizable array of storage receptacles.

### TECHNICAL FIELD

The present disclosure relates to trunks of motor vehicles.

### BACKGROUND

Motor vehicles may include a trunk with a trunk floor defining a space of the trunk for storing items. In some vehicles, the space may be segmented to form more than one storage receptacle for storing the items.

### SUMMARY

According to an embodiment, a vehicle trunk includes a retractable carriage that is extendable from a position flush with a floor of the trunk, and mountable to opposing walls of the trunk when extended. The trunk further includes retractable dividers that are extendable from the floor, each having a rod at a free end thereof. The carriage is configured to receive first ends of the rods for supporting the respective divider when extended to form a customizable array of storage receptacles.

According to another embodiment, a vehicle trunk includes a retractable carriage that is extendable through a first aperture formed in a floor of the trunk, and having opposing ends that are mountable to opposing walls of the trunk when extended. The trunk further includes a retractable divider that is extendable through a second aperture formed in the floor, and having a rod at a free end thereof with one end of the rod being mountable to the carriage when extended.

According to another embodiment, a vehicle trunk includes retractable dividers spaced across a floor of the trunk, each being extendible from the floor, and having a rod at a free end of the respective divider, such that a first end of each rod is receivable in any one of a first plurality of spaced-apart mounts, and a second end of each rod is receivable in any one of a second plurality of spaced-apart mounts disposed opposite the first plurality.

### BRIEF DESCRIPTION OF THE DRAWINGS

FIG. 1 is fragmentary perspective view of a vehicle trunk illustrating retractable dividers in various positions in accordance with an embodiment of the instant disclosure.

FIG. 2 is a fragmentary perspective view of a retractable carriage illustrated in the trunk of FIG. 1.

FIG. 3 is a fragmentary perspective view of the retractable divider illustrated in the trunk of FIG. 1.

FIG. 4 is a fragmentary cross-sectional view of a divider roller coupled to the retractable divider of FIG. 3.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

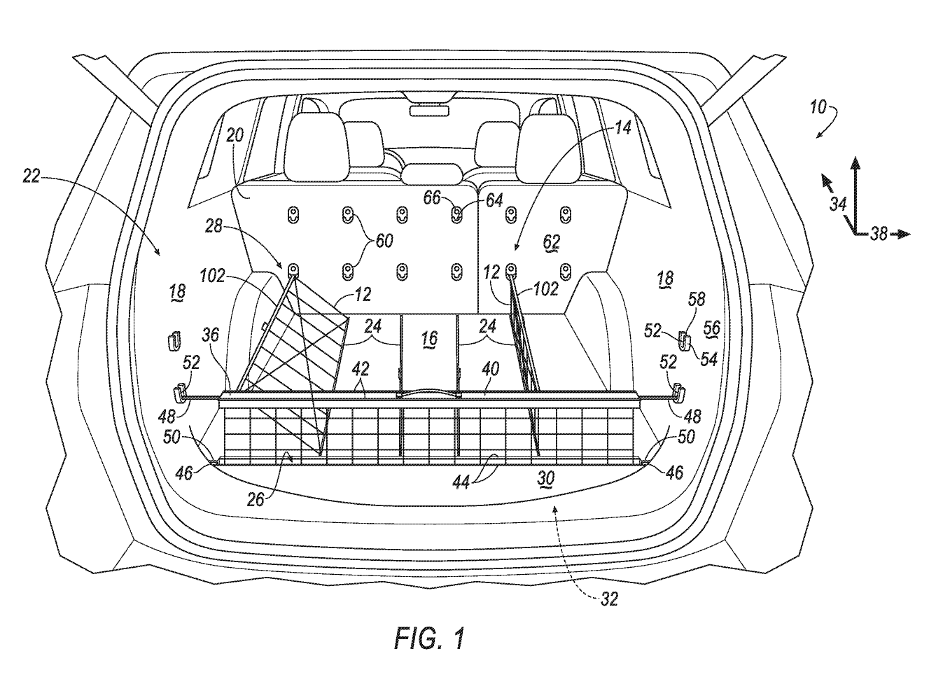

FIG. 1 is fragmentary perspective view of a vehicle trunk 10 illustrating retractable dividers 12 in various positions in accordance with an embodiment of the instant disclosure. The vehicle trunk 10 may be disposed at a rear of the vehicle and define a space 14 for storing items. In the illustrated embodiment, the trunk 10 has a trunk floor 16 for supporting items stored in the space 14. The trunk floor 16 may cover a spare wheel housed within a spare wheel cavity beneath the floor 16. In one embodiment, the floor 16 may span between opposing lateral walls 18 defining the vehicle trunk 10 and may also span between rear seats 20 and an opening 22 of the trunk 10. The floor 16 may have fore-aft apertures 24 and a lateral aperture 26 formed therein (described in more detail below).

The trunk 10 may also include the retractable dividers 12 that are configured to form a customizable array of storage receptacles 28 and constrain movement of the items stored therein when extended. The dividers 12 may be configured to segment the space 14 into the customizable array of storage receptacles 28. The dividers 12 may be spaced across the floor 16. The dividers 12 may be extendable from the floor 16 through the respective fore-aft aperture 24. FIG. 1 illustrates the outermost dividers 12 in different extended positions, and the innermost dividers 12 in the retracted position. The dividers 12 may be extended vertically or diagonally to accommodate the items stored therein. In the illustrated embodiment, the dividers 12 are configured as nets. However, the dividers 12 may take on other configurations in other embodiments. For example and without limitation, the dividers 12 may be flexible vinyl sheets.

Each of the fore-aft apertures 24 may be formed in the floor 16 and extend through a thickness of the floor 16 (between a top surface 30 and a bottom surface 32 of the floor 16). Each of the fore-aft apertures 24 may be configured to allow passage therethrough of the respective divider 12. In one embodiment, the fore-aft apertures 24 may be evenly spaced relative to one another between the walls 18 and may extend between the seats 20 and lateral aperture 26. In the illustrated embodiment, the floor 16 defines four fore-aft apertures 24 that are parallel to one another, each generally extending in fore-aft directions 34. One of ordinary skill in the art will understand that there may be any number of fore-aft apertures 24 and that they may extend in any number of directions. Furthermore, the fore-aft apertures 24 may be oriented differently relative to one another. In the illustrated embodiment, one divider 12 is extendable through one fore-aft aperture 24. In other embodiments, however, there may be more than one divider 12 that is extendable through one fore-aft aperture 24.

The trunk 10 may also include a retractable carriage 36 that is configured to support the dividers 12 in the extended position to form the customizable array of storage receptacles 28 when extended. The carriage 36 may be configured to segment the space 14. The carriage 36 may be disposed adjacent the opening 22 of the trunk 10 to be accessibly by a user. FIG. 1 illustrates the carriage 36 in an extended position. The carriage 36 may be extendable from the floor 16 through the lateral aperture 26.

The lateral aperture 26 may be formed in the floor 16 and extend through the thickness of the floor 16 (between the top and bottom surfaces 30, 32). The lateral aperture 26 may be configured to allow passage therethrough of portions of the carriage 36. In one embodiment, the lateral aperture 26 may extend between the opposing lateral walls 18 of the trunk 10. In the illustrated embodiment, the floor 16 defines one lateral aperture 26 that is generally oriented perpendicularly to the fore-aft apertures 24 and that extends in lateral directions 38 (which may be generally perpendicular to the fore-aft directions 34). One of ordinary skill in the art will understand that there may be any number of lateral apertures 26 that may extend in any number of directions. Furthermore, the fore-aft apertures 24 may be oriented differently relative to one another. In the illustrated embodiment, one carriage 36 is extendable through one lateral aperture 26. In other embodiments, however, there may be more than one carriage 36 that is extendable through one lateral aperture 24. Furthermore, there may more than one carriage 36.

The carriage 36 may have a main portion 40 that is elongate and is configured to receive and support the dividers 12 when extended (described in further detail below). The carriage 36 may also have wings 42 protruding from a top of the main portion 40. The wings 42 may be configured as stops to prevent the carriage 36 from retracting completely below the floor 16. When retracted, the wings 42 may rest on recessed areas 44 formed in the floor 16 adjacent the lateral aperture 26. The recessed areas 44 may be configured to receive the wings 42 in the retracted position. The recessed areas 44 may extend between longitudinal ends 46 of the lateral aperture 26 and be sized to allow passage of the main portion 40 of the carriage 36 between the recessed areas 44 and within the lateral aperture 26 when retracted. The wings 42 may extend the length of the recessed areas 44. However, one of ordinary skill in the art will understand that there is a number of configurations for the wings 42 and recessed areas 44. When retracted, the recessed areas 44 may receive the respective wing 42 such that the carriage 36 is flush with the floor 16.

The carriage 36 may also have opposing ends 48 that are mountable to the opposing lateral walls 18 of the trunk 10 when extended. In the illustrated embodiment, the ends 48 of the carriage 36 may be arms that protrude from the main portion 40 of the carriage 36 in opposite lateral directions 38. In the illustrated embodiment, the ends 48 are fixed relative to the main portion 40. However, in other embodiments, the ends 48 may be retractable as well such that the ends 48 are extendable away from the main portion 40. One of ordinary skill in the art will understand that there are other ways in which the carriage 36 may be extendable from a position flush with the floor 16 to a height above the floor 16 to support the dividers 12 in the extended position. For example and without limitation, the ends 48 of the carriage may slide within tracks formed in the opposing lateral walls 18 of the trunk 10.

The floor 16 may also define recessed areas 50 that extend in opposite lateral directions 38 from ends 46 of the lateral aperture 26. The recessed areas 50 may be configured to receive the ends 48 of the carriage 36 in the retracted position such that the carriage 36 is flush with the floor 16 in the retracted position.

In the retracted position, the carriage 36 may be flush with the floor 16. Specifically, top surfaces of the main portion 40, ends 48, and wings 42 may be flush with the top surface 30 of the floor 16 when retracted. In other embodiments, the carriage 36 may be disposed slightly above the floor 16 when retracted.

Still referring to FIG. 1, in the illustrated embodiment, each of the opposing lateral walls 18 of the trunk 10 has two recesses 52 formed therein at two different heights. As such, the carriage 36 may be extended to two different extended positions corresponding to the two different heights. Each of the recesses 52 may be configured to receive the respective opposing end 48 of the carriage 36 when extended. As illustrated, the recesses 52 may be formed in protrusions 54 that extend from a base surface 56 of the respective wall 18. The recesses 52 may be configured to restrain movement of the respective end 48 of the carriage 36 in the fore-aft directions 34. The recesses 52 may also be configured such that the user may lift and lower the ends 48 out of and into the recesses 52 as desired. For example, an opening 58 defined by the protrusion 54 may be disposed above the recess 52 for allowing access to the recess 52 from above.

Still referring to FIG. 1, the trunk 10 may further include a plurality of spaced-apart mounts 60 for supporting the dividers 12 when extended. The mounts 60 may be disposed along an interior wall 62 of the trunk 10 opposite the opening 22 and carriage 36. In the illustrated embodiment, the interior wall 62 may be defined by the seats 20, e.g., by the seatbacks of the rearmost seats 20. Each of the mounts 60 may be shaped to define a valley 64 for supporting at least one of the dividers 12 at a time. Each of the mounts 60 may include an aperture 66 above the respective valley 64 for receiving a bolt to couple the mount 60 to the interior wall 62. As shown, there may be several mounts 60 spaced apart from one another over the interior wall 62 for supporting various dividers 12 in various configurations. Furthermore, the mounts 60 may be disposed at varying heights with the dividers 12 being configured to extend to the varying heights, as desired.

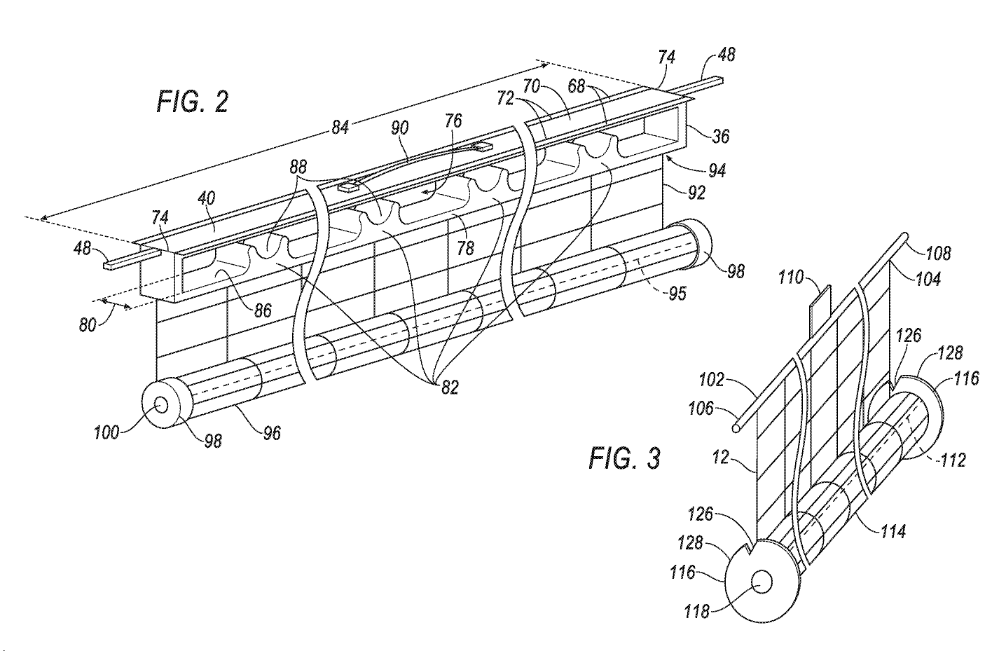

FIG. 2 is a fragmentary perspective view of the carriage 36 illustrated in the trunk 10 of FIG. 1. As described above, the carriage 36 may have the main portion 40 which may be elongate and have a generally rectangular outer cross-section. The wings 42 may protrude from the top of the main portion 40 such that the top surfaces 68, 70 of the wings 42 and main portion 40, respectively, are generally flush with one another or form a planar surface. The wings 42 may protrude from front and rear edges 72 defining the top surface 70 of the main portion 40 in opposite fore-aft directions 34.

The ends 48 of the carriage 36 may protrude from the top of the main portion 40. The ends 48 may protrude from longitudinal ends of the main portion 40 in opposite lateral directions 38. Each of the ends 48 may protrude from lateral edges 74 that define and top surface 70 of the main portion 40.

The main portion 40 may define a cavity 76 facing away from the opening 22 of the trunk 10 (FIG. 1). The cavity 76 may be formed in a surface 78 facing the dividers 12 (FIG. 1) and extend to a depth 80. In some embodiments, the cavity 76 extends through the main portion 40 to form a thru-hole.

The carriage 36 may also have a plurality of spaced-apart mounts 82 disposed along a length 84 of the main portion 40 of the carriage 36, each mount 82 being configured to receive at least one of the ends of the dividers 12 to support the respective divider(s) 12 when extended (FIG. 1). As shown in FIG. 1, the mounts 82 in the carriage 36 may be disposed opposite the mounts 60 disposed along the interior wall 62 of the trunk 10. The mounts 82 in the carriage 36 may be disposed adjacent the opening 22 of the trunk 10.

With reference to FIG. 2, the mounts 82 may be evenly spaced relative to one another and be disposed at the same height above the floor when extended. In other embodiments, the mounts 82 may be disposed unevenly and/or at different height relative to one another. The mounts 82 may be generally U-shaped in cross section and protrude upwards from a bottom interior surface 86 defining the cavity, 76 such that ends of the rods of the dividers 12 may be received and supported in valleys 88 of the mounts 82. One of ordinary skill in the art will understand that there are several ways to form a mount 82 for receiving and supporting the dividers 12 in the extended position. In the illustrated embodiment, there are six mounts 82 disposed in the carriage 36 to match the six mounts 60 disposed at the same height along the interior wall 62 of the trunk 10. The mounts 82 in the carriage 36 may be aligned with the mounts 60 on the interior wall 62 such that the divider(s) 12 may be generally oriented perpendicularly relative to the main portion 40 of the carriage 36 and/or along the fore-aft directions 34. Although the illustrated embodiment shows the mounts 82 being disposed in the carriage 36, in other embodiments, the mounts 82 may be disposed elsewhere in the trunk 10. For example and without limitation, the mounts 82 may be disposed below the opening 22 and formed in an interior wall of the trunk 10 extending between the opposing lateral walls 18 opposite the interior wall 62.

With continued reference to FIG. 2, the carriage 36 may also include a handle 90 mounted to the top surface 70 of the main portion 40 to allow the user to lift and lower the carriage 36. The handle 90 may protrude above the floor 16 (FIG. 1) when the main portion 40 of the carriage 36 is disposed within the lateral aperture 26 (FIG. 1) in the retracted position.

Still referring to FIG. 2, the carriage 36 may further include a partition 92 configured to segment the space 14 and form the array of storage receptacles 28 (FIG. 1). The partition 92 may have a free end 94 coupled to a bottom of the main portion 40 such that in the extended position, at least a portion of the partition 92 is disposed above the floor 16 and within the space 14, and in the retracted position, the partition 92 is disposed below the floor 16 outside the space 14. In the illustrated embodiment, the partition 92 is configured as a net. However, the partition 92 may take on other configurations in other embodiments. For example and without limitation, the partition 92 may be a flexible vinyl sheet.

The carriage 36 may be spring-loaded and have a lower end 95 opposite the free end 94 that is coupled to a carriage roller 96. The carriage roller 96 may be configured to rotatably bias the main portion 40 to the retracted position. The carriage roller 96 may extend between two end caps 98. The carriage roller 96 may be rotatably coupled or supported below the floor 16 by the end caps 98. The end caps 98 may be configured to rotatably support the carriage roller 96 as the carriage 36 moves between the retracted and extended positions. The end caps 98 may be fixed relative to the carriage roller 96 and be mounted to or be suspended from the bottom surface 32 of the floor 16 (FIG. 1) via a bracket or the like. In one embodiment, L-shaped pegs may be mounted to the bottom surface 32 of the floor 16 (FIG. 1) and protrude into apertures 100 extending through the respective end cap 98 and carriage roller 96. One of ordinary skill in the art will understand that there are other ways to rotatably support the carriage roller 96 below the floor 16 with or without the end caps 98 or the like.

FIG. 3 is a fragmentary perspective view of the retractable divider 12 illustrated in the trunk 10 of FIG. 1. Although the retractable dividers 12 in the illustrated embodiment are similar in size and shape, the retractable dividers 12 may be dissimilar in size and/or shape in other embodiments. The divider 12 may have a rod 102 at a free end 104 thereof. The rod 102 may be rigid such that moving one end 106 of the rod 102 adjacent the opening 22 of the trunk 10 (FIG. 1) causes the other end 108 opposite the end 106 to generally move the same degree (along with the divider 12) such that the ends 106, 108 of the rod 102 may be positioned in the desired mounts 60, 82 (FIG. 1) with ease. The rod 102 may have an elongate shape and have a length greater than a length of the divider 12 such that the ends 106, 108 of the rod 102 extend past the respective ends of the divider 12 for mounting to the respective mounts 60, 82 (FIG. 1). The mounts 60 in the interior wall 62 may be configured to receive the end 108 of at least one of the rods 102 to support the respective divider 12 when extended. The carriage 36 or the mounts 82 in the carriage 36 may be configured to receive the end 106 of at least one of the rods 102 to support the respective divider 12 when extended. Although the rod 102 is illustrated as being cylindrical, the rod 102 may take on other shapes or sizes within the spirit and scope of the instant disclosure. Furthermore, although the rod 102 is illustrated as being generally straight, the rod 102 may be curved or non-straight in accordance with other embodiments. In one embodiment, the rod 102 may be plastic or metal.

In the illustrated embodiment, the ends 106, 108 of the rod 102 are selectively mountable to the mounts 60, 82 in the trunk 10 (FIG. 1) between the extended and retracted positions. In some embodiments, the ends 106, 108 of the rod 102 may be mounted to the mounts 60, 82 in both the retracted and extended positions. For example and without limitation, the mounts 60, 82 may be moveable mounts such as tracks, wherein the ends 106, 108 of the rod 102 are received within the tracks and are slidable to various positions.

Still referring to FIG. 3, the rod 102 may have a grip 110 coupled thereto that protrudes from the respective fore-aft aperture 24 (FIG. 1) in the retracted position such that the user may lift the rod 102 out of the respective aperture 24 and into the extended position. Although the grip 110 is illustrated as being generally disposed in the center of the rod 102, the grip 110 may be disposed at other locations along the rod 102. Furthermore, in another embodiment, a relatively small recess or additional aperture may be formed in the floor 16 adjacent the respective fore-aft aperture 24 to allow the user to grip underneath the rod 102 and lift the rod to an extended position.

With reference to FIG. 3, the divider 12 may be spring-loaded and have a lower end 112 opposite the free end 104 that is coupled to a divider roller 114. The divider roller 114 may be configured to rotatably bias the rod 102 to a retracted position in which the rod 102 is adjacent to the floor 16 (FIG. 1). The divider roller 114 may extend between two end caps 116. The divider roller 114 may be rotatably coupled or supported below the floor 16 (FIG. 1) by the end caps 116. The end caps 116 may be configured to rotatably support the divider roller 114 and to guide the divider 12 as it winds and unwinds around the divider roller 114 between the retracted and extended positions. The end caps 116 may be fixed relative to the divider roller 114 and be mounted to or be suspended from the bottom surface 32 of the floor 16 (FIG. 1) via a bracket or the like. In one embodiment, L-shaped pegs may be mounted to the bottom surface 32 of the floor 16 (FIG. 1) and protrude into apertures 118 extending through the respective end cap 116 and divider roller 114. One of ordinary skill in the art will understand that there are numerous ways to rotatably support the divider roller 114 below the floor 16 with or without the end caps 116 or the like.

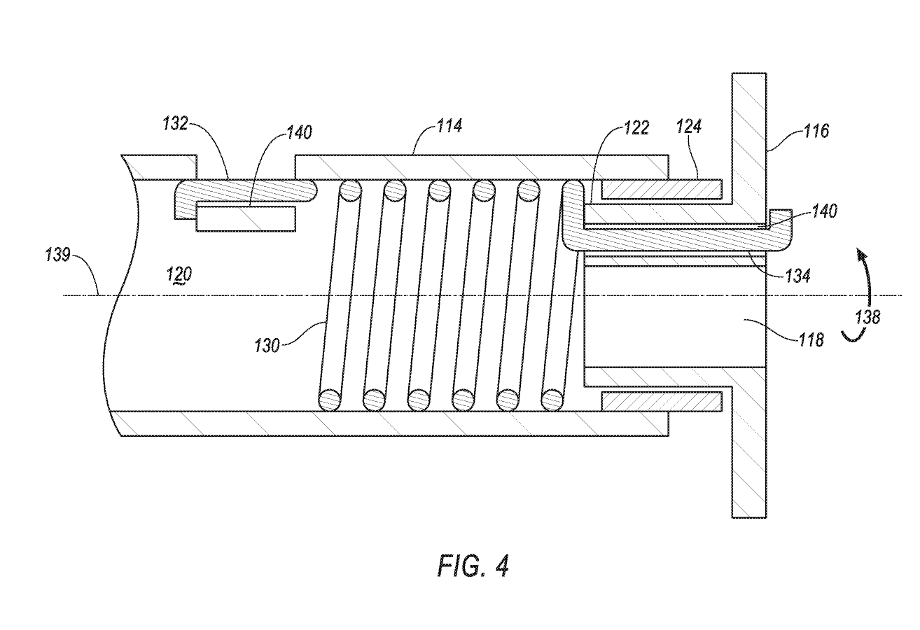

FIG. 4 is a fragmentary cross-sectional view of the divider roller 114 coupled to the divider 12 of FIG. 3. Although one end cap 116 is illustrated in the figure, the below description may apply to the other end cap 116 in some embodiments. Furthermore, in some embodiments, the carriage 36 may also be spring-loaded in a similar manner as shown and described below in connection FIG. 4. A nipple 122 coupled to and extending inwardly toward the roller 114 from the end cap 116 may be disposed within a circular ball bearing 124, and the roller 114 may be inserted over the ball bearing 124 such that the roller 114 may rotate relative to the nipple 122, which may be fixed to or be integral with the end cap 116, upon moving between the retracted and extended positions. Although a ball bearing 124 is illustrated as being used to decrease friction between the roller 114 and nipple 122, one of ordinary skill in the art will recognize other embodiments, such as bushings, lubricated surfaces, or self-lubricating materials (e.g., PTFE).

Referring to FIG. 3, the end cap 116 may have a diameter greater than a diameter of the roller 114 to retain the divider 12 around the roller 114. Each of the end caps 116 may have a notch 126 formed in a respective outer circumferential edge 128 for receiving the rod 102 (FIG. 3) when in the retracted position such that the rod 102 remains accessible to the user. The notch 126 may be disposed adjacent the respective fore-aft aperture 24 (FIG. 1) such that the rod 102, when retracted and disposed within the notch 126, may be lifted out through the respective fore-aft aperture 24 with ease upon moving to the extended position. In the illustrated embodiment, the rod 102 is disposed beneath the floor 16 adjacent the bottom surface 32 of the floor 16 with the grip 110 protruding through the respective fore-aft aperture 24 and into the space 14 (FIG. 1). However, in other embodiments, the rod 102 may be disposed within the floor 16, be flush with the floor 16, or above the floor 16 adjacent the top surface 30 in the retracted position. For example and without limitation, the fore-aft aperture 24 may be sized such that the divider 12 may pass through the aperture 24 without allowing the rod 102 to pass through as well. In which case, the rod 102 may lie on the floor 16 in the retracted position or in a recessed area adjacent the aperture 24 that is sized to receive the rod 102 to be flush with or within the floor 16 when retracted. Although the notch 126 is illustrated as being generally V-shaped, the notch 126 may take on a variety of different shapes and sizes in other embodiments. Furthermore, the notches 126 may be disposed at the same circumferential location on the outer circumferential edges 128 of the end caps 116 to align the rod 102 relative to the roller 114 and to the fore-aft aperture 24.

Referring to FIG. 4, in one embodiment, the roller 114 may be spring-loaded to bias the divider 12 to the retracted position. As shown in FIG. 4, a spring 130 may be disposed in an interior 120 of the roller 114 and have ends 132, 134. The end 132 may be fixedly coupled to the roller 114. The end 134 may be fixedly coupled to the adjacent end cap 116. The ends 132, 134 of the spring 130 may be coupled to the roller 114 and end cap 116 such that the end 132 coupled to the roller 114 is biased to move toward a neutral position causing the roller 114 to rotate in a rotational direction 138 relative to a longitudinal axis 139. The neutral position may be a position in which no forces act on the spring 130 and the spring 130 is at rest. The spring 130 may be coiled or uncoiled from the neutral position to a loaded position and be coupled to the roller 114 and end cap 116 in the loaded position such that the spring 130 (having a tendency to return to the neutral position) may urge the roller 114 to rotate in the rotational direction 138. Upon the divider 12 moving from the extended position to the retracted position, the spring 130 may urge the roller 114 to rotate in the rotational direction 138, thus causing the divider 12 to wind around the roller 114 and bring the rod 102 (FIG. 3) to the retracted position adjacent the floor 16 (FIG. 1).

Still referring to FIG. 4, the ends 132, 134 of the spring 130 may be inserted through slots or apertures 140 formed in the roller 114 and end cap 116, respectively. An adhesive may also be used to couple the ends 132, 134 of the spring 130 to the roller 114 and end cap 116. The spring 130 may be similar to the helical torsion springs discussed in the following patent references, each of which is incorporated by reference in its entirety as though fully set forth herein: U.S. Pat. No. 5,357,239 and U.S. Pat. No. 4,792,871.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure. Furthermore, details disclosed in connection with one embodiment apply to other disclosed embodiments as well, unless specified otherwise.

1. A vehicle trunk comprising:
a retractable carriage that is extendable from a retracted position where a top surface of the carriage is flush with a floor of the trunk, and mountable to opposing walls of the trunk when extended; and
retractable dividers that are extendable from the floor, each having a rod at a free end thereof, the carriage having mounts configured to receive first ends of the rods for supporting the respective divider when the carriage is extended to form a customizable array of storage receptacles, wherein the mounts are disposed on the carriage below the top surface such that the mounts are positioned below the floor when the carriage is in the retracted position.

2. The vehicle trunk of claim 1, further comprising spaced-apart mounts disposed along an interior wall of the trunk opposite the carriage and at least partially defined by seatbacks in the vehicle, each of the mounts being configured to receive a second end of at least one of the rods to support the respective divider when extended.

3. The vehicle trunk of claim 1, wherein the mounts are disposed along a length of the carriage.

4. The vehicle trunk of claim 1, wherein opposing ends of the carriage are mountable to the opposing walls of the trunk when extended.

5. The vehicle trunk of claim 4, wherein the opposing walls of the trunk are lateral walls, and wherein each of the opposing walls of the trunk has a recess formed therein for receiving the respective opposing ends of the carriage when extended.

6. The vehicle trunk of claim 1, wherein each of the dividers has a lower end opposite the respective free end coupled to a divider roller that is configured to rotatably bias the respective rod to a position adjacent the floor, and wherein each of the divider rollers is rotatably supported below the floor.

7. The vehicle trunk of claim 6, wherein each of the dividers winds around the respective divider roller when retracted.

8. The vehicle trunk of claim 6, wherein each of the divider rollers extends between two end caps that are fixed relative to the respective divider roller, and wherein each of the end caps has a notch formed therein for receiving the respective rod when retracted.

9. The vehicle trunk of claim 6, wherein each of the divider rollers is spring-loaded.

10. A vehicle trunk comprising:
a retractable carriage that is extendable from a retracted position, where a top surface of the carriage is flush with a floor of the trunk, through a first aperture formed in a floor of the trunk, having opposing ends that are mountable to opposing walls of the trunk when extended, and having spaced-apart mounts that are disposed on the carriage below the top surface such that the mounts are positioned below the floor when the carriage is in the retracted position; and
a retractable divider that is extendable through a second aperture formed in the floor, and having a rod at a free end thereof with one end of the rod being mountable to each of the spaced-apart mounts when the carriage is extended.

11. The vehicle trunk of claim 10, wherein the divider has a lower end opposite the free end coupled to a divider roller that is configured to rotatably bias the rod of the divider to a retracted position adjacent the floor, and wherein the divider roller is rotatably supported below the floor.

12. The vehicle trunk of claim 11, wherein the divider winds around the roller in the retracted position.

13. The vehicle trunk of claim 10, wherein the carriage has a main portion and wings protruding therefrom, and wherein the floor of the trunk defines recesses adjacent the first aperture that are configured to receive the wings of the carriage such that the carriage is flush with the floor in a retracted position.

14. The vehicle trunk of claim 10, wherein the opposing ends of the carriage protrude from a main portion of the carriage, and wherein each of the opposing walls of the trunk has a recess formed therein for receiving the respective ends of the carriage when extended.

15. The vehicle trunk of claim 10, wherein the carriage has a main portion and the spaced-apart mounts are disposed along the main portion.

16. The vehicle trunk of claim 15, wherein the carriage has a retractable partition with a free end coupled to the main portion.

17. The vehicle trunk of claim 16, wherein the partition has a lower end opposite the free end that is coupled to a carriage roller configured to rotatably bias the main portion of the carriage to a retracted position flush with the floor, and wherein the carriage roller is rotatably supported below the floor.

18.-20. (canceled)

21. The vehicle trunk of claim 1, wherein the carriage defines a cavity between the top surface and a bottom interior surface of the carriage, and wherein the mounts extend upward and into the cavity from the bottom interior surface.

22. The vehicle trunk of claim 10, wherein the carriage defines a cavity between the top surface and a bottom interior surface of the carriage, and wherein the mounts extend upward and into the cavity from the bottom interior surface.

23. A vehicle trunk comprising:
an extendable carriage having a top surface that is flush with a trunk floor when the carriage is retracted, defining a cavity below the top surface, and having mounts that extend into the cavity from a bottom interior surface; and
a retractable divider that is extendable from the floor, and having a rod that is configured to engage the mounts when the carriage is extended to form storage receptacles.
